(19) United States
(12) Patent Application Publication
(10) Pub. No.: US 2026/0261533 A1
(43) Pub. Date: Sep. 3, 2026

(54) DIGITAL AGENTS FOR PRESENCE IN COMMUNICATION SESSIONS

(71) Applicant: Microsoft Technology Licensing, LLC, Redmond, WA (US)

(72) Inventor: Ryen W. WHITE, Woodinville, WA (US)

(73) Assignee: Microsoft Technology Licensing, LLC, Redmond, WA (US)

(21) Appl. No.: 19/629,347

(22) Filed: Mar. 26, 2026

Related U.S. Application Data
(63) Continuation of application No. 17/246,021, filed on Apr. 30, 2021, now abandoned.

(51) Int. Cl. H04L 51/02; H04L 65/403

(52) U.S. Cl. CPC H04L 51/02; H04L 65/403

(57) ABSTRACT

One or more digital agents are instantiated to monitor to monitor one or more communication sessions on behalf of a user. Respective digital agents are configured to identify, in the information shared during respective communication sessions, respective one or more subsets of information including one or more items of information relevant to the user. The respective one or more subsets of information identified, by the respective one or more digital agents, are obtained from the one or more digital agents. At least some of the information in the respective subsets of information is presented to the user.

### BACKGROUND

Virtual communications or other types of exchange of information between people using various computing devices (e.g., computers, smart phones, etc.) are routinely used in various forms and settings. For example, communication sessions, such as audio and/or video conferencing meetings, are routinely conducted between participants using respective computing devices of the participants. As another example, presentations may be live-streamed or otherwise virtually provided to participants via respective computing devices of the participants. With such widespread use of virtual communications, people often find themselves unable to attend virtual meetings or other virtual events, for example due to timing conflicts with other virtual meetings or virtual events. Typically, a person is able to attend at most one communication session at any given time and must forgo attendance at one or more other communication sessions occurring at the same time.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

In accordance with examples of the present disclosure, digital agents are provided that may attend communication sessions, such as virtual meetings or other virtual events, on behalf of users who may be unable to personally attend the communication sessions due, for example, to conflicts with other meetings or events. In an aspect, a digital agent may be instantiated to monitor information that may be shared between participants during a meeting, such as comments made during the meeting, questions asked during the meeting, documents displayed during the meeting, chats typed during the meeting, etc. The digital agent may be trained or otherwise configured to identify, in the information shared during the meeting, items of information that may be relevant to the user, such as comments, points, documents (or portion of documents) that contain information relating to a topic of interest to the user, questions within an area expertise of the user, specific mentions of the user's name, etc. In aspects, the items of information identified by the digital agent as relevant to the user may then be presented to the user, in some form, in real-time during the meeting or as a summary after the meeting. In these ways, the user may be provided with relevant information from a communication session at appropriate times throughout or after the communication session and without personally attending the communication session.

In aspects, a system is provided. The system comprises one or more computer readable storage media and program instructions stored on the one or more computer readable storage media that, when executed by at least one processor, cause the at least one processor to perform operations. The operations include instantiating a digital agent to monitor information shared during a communication session on behalf of a user, the digital agent configured to identify, in the information shared during the communication session, a subset of information that information relevant to the user. The operations also include obtaining the subset of information identified, by the digital agent, in the information shared during the communication session. The operations further include determine whether respective one or more items of information, in the subset of information, are to be presented to the user. The operations additionally include, in response to determining that particular one or more items of information in the subset of information are to be presented to the user, cause the one or more particular items of information in the subset of information to be presented to the user.

In further aspects, a computer-implemented method for providing meeting information is provided. The method includes instantiating one or more digital agents to monitor information shared during one or more communication sessions on behalf of a user, wherein respective digital agents, among the one or more digital agents, are configured to identify, in the information shared during respective communication sessions among the one or more communication sessions, respective one or more subsets of information including one or more items of information relevant to the user. The method also includes obtaining the respective one or more subsets of information identified, by the respective one or more digital agents, in the information shared during the one or more communication sessions. The method additionally includes causing at least some of the items of information in the respective subsets of information to be presented to the user.

In still further aspects, a computer storage medium is provided. The computer storage medium stores computer-executable instructions that when executed by at least one processor cause a computer system to perform operations. The operations include instantiating a digital agent to monitor at least one meeting on behalf of a user, the digital agent configured to identify, in information shared during the meeting, a subset of information that includes information relevant to the user. The operations also include obtaining the subset of information identified, by the digital agent, in the information shared during the meeting. The operations further include determining whether respective one or more items of information, in the subset of information, are to be presented to the user. The operations also include, in response to determining that particular one or more items of information in the subset of information are to be presented to the user, cause the particular one or more items of information in the subset of information identified by the digital agent to be presented to the user.

### BRIEF DESCRIPTION OF THE DRAWINGS

Non-limiting and non-exhaustive examples are described with reference to the following Figures.

FIG. 1 illustrates an overview of an example system in which digital agents may be utilized to attend communication sessions on behalf of user who may personally be not present at the communication sessions, in accordance with aspects of the present disclosure.

FIG. 2 depicts an example of a digital agent, in accordance with aspects of the present disclosure.

FIG. 3 depicts an example of a digital agent presence system, in accordance with aspects of the present disclosure.

FIG. 4 depicts an example of a digital agent coordination system, in accordance with aspects of the present disclosure.

FIG. 5 depicts details of a method for providing information from a communication session to a user who is not personally attending the communication session, in accordance with aspects of the present disclosure.

FIG. 6 is a block diagram illustrating physical components (e.g., hardware) of a computing device with which aspects of the disclosure may be practiced.

FIGS. 7A-7B illustrate a mobile computing device with which aspects of the disclosure may be practiced.

FIG. 8 illustrates an example architecture of a system in which aspects of the disclosure may be practiced.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the present disclosure. Aspects disclosed herein may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In accordance with examples of the present disclosure, digital agents are provided that may be dispatched to attend communication sessions, such as video or audio conferencing meetings, on behalf of users who may be unable to personally attend the communication sessions due, for example, to timing conflicts with other communication sessions being personally attended by the users. A digital agent attending a communication session on behalf of a user may monitor information that may be shared during the communication session (e.g., comments made during the communication session, questions asked during the communication session, documents displayed during the communication session, chats typed during the communication session, etc.) to identify, in the information shared during the communication session, items of information that be relevant to the user. For example, the digital agent may identify, in the information shared during the communication session, items of information relating to certain topics that may be of interest to the user, questions that may be within an area of expertise of the user, information containing specific mentions of the user's name, etc. The items of information identified by the digital agent as being relevant to the user may be communicated to the user, in real-time during the communication session and/or as a summary that may be provided to the user after completion of the communication session. In some aspects, multiple such digital agents may be dispatched to attend multiple concurrent or simultaneous communication sessions on behalf of a user, and the user may be presented with items of information identified by the multiple digital agents as being relevant to the user, as appropriate, in real-time during the multiple communication sessions and/or as a summary after completion of the communication sessions. In these ways, the user may be provided with relevant information from communication sessions without personally attending the communication sessions, for example while the user is personally attending another (e.g., a more important) communication session.

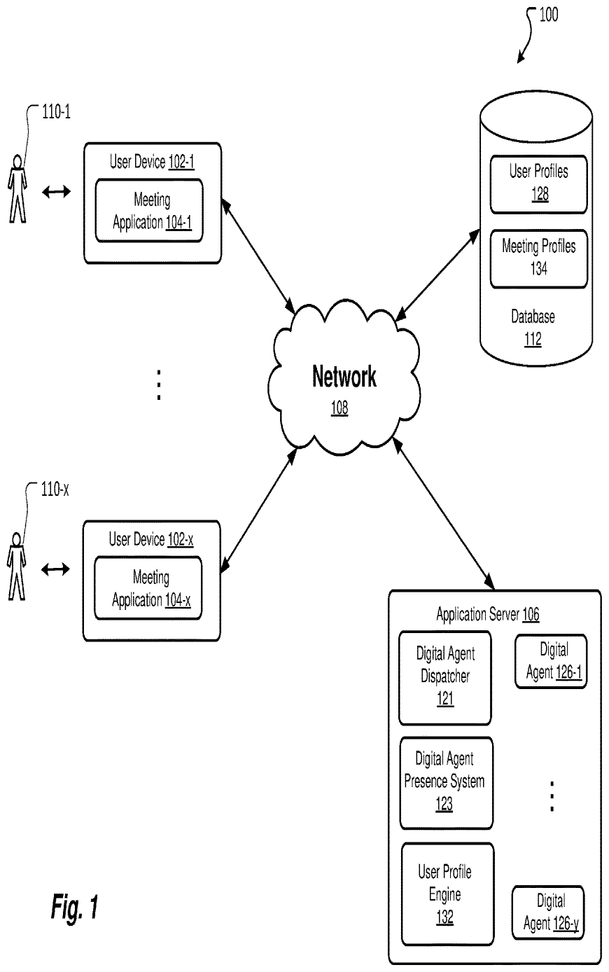

FIG. 1 illustrates an overview of an example system 100 in which digital agents may be dispatched to attend communication sessions, such as meetings, on behalf of users who may be unable to personally be present at the communication sessions, in accordance with aspects of the present disclosure. A digital agents may be an intelligent applications or processes that utilize artificial intelligence (AI) approaches to provide the functionality described herein. Such intelligent digital agents may, for example, utilize models trained using the user profile information to simulate personalized features such as the expertise, knowledge and decision-making characteristics of the individual. Such an intelligent digital agent may also be trained based on information representative of one or more previous meetings in which the user has participated, or previous meetings between the particular group of participants. The system 100 may include one or more user devices 102 that may be configured to run or otherwise execute client applications 104. The one or more user devices 102 may include, but are not limited to, laptops, tablets, smartphones, and the like. The applications 104 may include applications having meeting features (“meeting applications”), such as applications that may allow the user to virtually attend various communication sessions, such as video conferencing communication sessions, audio conferencing communication sessions, streaming presentation sessions and the like. Non-limiting examples of applications 104 include Microsoft™ Teams™ and Microsoft™ Skype™. In some examples, the applications 104 may include web applications, where such applications 104 may run or otherwise execute instructions within web browsers. In some examples, the applications 104 may additionally or alternatively include native client applications residing on the user devices 102.

The one or more user devices 102 may be communicatively coupled to an application server 106 via a network 108. The network 108 may be a wide area network (WAN) such as the Internet, a local area network (LAN), or any other suit able type of network. The network 108 may be single network or may be made up of multiple different networks, in some examples. The meeting applications may allow users 110 to access various meetings, such as corporate meetings, conferences, presentations and the like that may be hosted on the meeting application server 106, for example. The system 100 may also include a database 112. The database 112 may be communicatively coupled to the application server 106 and/or to the one or more user devices 102 via the network 108, as illustrated in FIG. 1, or may be coupled to the application server 106 and/or to the one or more user devices 102 in other suitable manners. For example, the database 112 may be directly connected to the application server 106, or may be included as part of the application server 106, in some examples. In various aspects, the database 112 may be a single database or may include multiple different databases.

The application server 106 may include a digital agent dispatcher 121 and a simultaneous presence system 123. The digital agent dispatcher 121 may be configured to dispatch or otherwise instantiate digital agents 126 to attend communication sessions on behalf of users 110. The digital agents 126, dispatched by the digital agent dispatcher 121, may be executing or otherwise running on the application server 106 as illustrated in FIG. 1 or may be executing or otherwise running on other devices, such as user devices 102 or servers other than the application server 106, that may be coupled directly or indirectly (e.g., via the network 108) to the application server 106. In some aspects, the digital agents 126 may include respective digital agents 126 dispatched to attend respective ones of multiple communication sessions that may be overlapping in time (e.g., concurrent or parallel-in-time communication sessions) on behalf of a particular user 110. In some aspects, the digital agents 126 may additionally or alternatively include multiple digital agents 126 dispatched to attend a particular communication session on behalf of multiple users 110. For ease of explanation, digital agents 126 are generally described herein in the context of attending meetings on behalf of users 110. In other aspects, however, digital agents 126 may be dispatched to attend communication sessions other than meetings, such as presentations, conferences, steering video sessions, etc. on behalf of the users 110.

In aspects, the digital agents 126 associated with particular users 110 may be trained or otherwise configured to monitor information shared during meetings that the digital agents 126 are attending on behalf of the particular users 110, such as comments made during the meeting, questions asked during the meeting, documents displayed during the meeting, chats typed during the meeting, etc., and to identify, in the information shared during the meeting, items of information that may be relevant to the particular users 110. In an aspect, a digital agent 126 associated with a particular user 110 may include one or more artificial intelligence (AI) modules (e.g., neural networks) or other types of modules that may be trained or otherwise configured to identify, in various types of information that may be shared during a meeting, specific information, such as comments or points relating to certain topics that may be of interest to the user 110, portions of documents, such as presentation slides, that contain information that may be of interest to the user, questions that may be within an area of expertise of the user, comments that may mention the user's name, etc. In some aspects, the digital agent 126 may be configured to identify the items of information that may be relevant to particular users 110 based, at least in part, on user profiles 128 that may be stored, in the database 112, in association with identifiers associated with the users 110 (e.g., user IDs associated with the users 110). In an aspect, respective user profiles 128 may include user information indicative of information, such as areas or topics of importance or interest, that may be relevant to the respective users 110. In aspects, a user profile 128 associated with a user 110 may enable a digital agent 126 dispatched to attend a meeting on behalf of the user 110 to model characteristics of the user 110, such as knowledge, expertise, etc. that may be possessed by the user 110.

User profiles 128 associated with users 110 may be generated and/or maintained by a user profile engine 132 that may be running or otherwise executing on the application server 106. In some aspects, at least a portion of the functionality of the user profile engine 132 may implemented by one or more suitable devices other than the application server 106. For example, at least a portion of the functionality of the user profile engine 132 may be implemented by a user device 102 and/or a server device other than the application server 106. Further, although the user profile engine 132 is illustrated in FIG. 1 as being separate from the digital agents 126, the user profile engine 132 may be included as a part of each digital agent 126.

The user profiles engine 132 may be configured to generate and/or maintain (e.g., update) a user profile 128 for a user 110 based on a body of information that may include information known about the user 110 and/or information that may allow the user profiles engine 132 to make determinations or inferences regarding knowledge, expertise, personality traits, etc., of the user 110. In various aspects, the body of information that may be used by the user profile engine 132 to generate and/or update a user profile 128 for a user 110 may include one or more of i) statements made by the user 110 during previous meetings, ii) statements or other information that the user 110 posted on social media platforms, iii) documents or notes authored by, or otherwise associated with, the user 110, iv) audio or video recording of speeches or presentations made by the user 110, v) content of electronic communication messages, such as emails, associated with the user 110, etc. In an aspect, the user profile engine 132 may be configured to infer areas of knowledge, expertise, interest or other relevance to the user 110 based, for example, on a number of times certain words, terms, topics, etc. appear in the body of user information that may be analyzed by the user profile engine 130 for the user 110. For example, the user profile engine 132 may determine that a user 110 is an expert on a topic if certain terms or phrases associated with the topic are mentioned, in the body of information associated with the user 110, a number of times that accedes a threshold. Of course, other suitable analysis and inference techniques may additionally or alternatively be utilized by the user profile engine 132 to infer areas of knowledge, expertise, interest or other relevance to the user 110.

The user profiles 128 may additionally or alternatively include other information that may be known about the users 110, such as personal information and/or characteristics that may be provided by the users 110. For example, a user profile 128 associated with a user 110 may include the user's name, the user's address and/or other indication of the user's geographical location, the user's occupation, the user's enterprise or organization, the user's title and/or role within the enterprise or organization, etc. In some aspects, the user profiles 128 may include indications of areas of relevance to the users 110 that may be explicitly provided by the users 110. For example, a user 110 may indicate or otherwise select, via the user interface of the meeting application 104, particular topics or areas of interest, among the topics that were inferred based on the user profile 128 associated with user 110, for which the user 110 wishes the digital agent 126 to monitor one or more meetings on behalf of the user 110. Such indications or selections may be made by the user 110 for a particular meeting or for multiple meetings, such as meetings of particular types (e.g., presentations, corporate meetings, etc.), or such selections made by the user 110 may generally persist across all meetings attended by the digital agent 126 on behalf of the user 110.

In aspects, the digital agents 126 may additionally or alternatively be configured to analyze information shared during the meeting to identify items of information relating to one or more additional topics or areas, or containing one or more additional words, phrases, etc., that may be explicitly specified by the users 110. For example, a user 110 may indicate (e.g., via a user interface of the meeting application 104) specific areas of interest or specific words, phrases, etc., relating to information that the user 110 may wish to obtain from a meeting. In aspects, the user 110 may indicate the specific areas of interest for respective meetings to which the user 110 may wish to dispatch a digital agent 126 and/or may more generally indicate the specific areas of interest for multiple (e.g., all) meetings to which the user 110 may wish to dispatch the digital agent 126.

In some aspects, a user profile 128 that may be generated and/or maintained by the user profile engine 132 may be associated with a group of multiple users, such as multiple users associated with a particular work group, a particular enterprise, etc. Such user profile 128 may enable a digital agent 126 that may be dispatched to attend a meeting on behalf of the group of multiple users to identify, in monitored meeting information, a subset of information that may be relevant to the group of multiple users, such as information relating to topics of interest or within areas of expertise of the group of multiple users.

In aspects, the digital agent dispatcher 121 may be configured to dispatch a digital agent 126 to attend a meeting on behalf of a user 110 (or on behalf of a group of users 110) in response to a request that may be received from the user 110. For example, the user 110 may enter the request into a user interface of a meeting application 104 on a user device 102 of the user 110. In some examples, the user 110 may request a digital agent 126 to be dispatched to attend a meeting on behalf of the user 110 when the user 110 responds to an invitation to the meeting that may be provided, for example in an email, to the user 110. In some aspects, the user 110 may click on, or otherwise engage with, a button that may be displayed, for example, in the user interface of the meeting application 104 to request dispatch of a digital agent 126 to attend the meeting on behalf of the user 110. In some aspects, the digital agent dispatcher 121 may be configured to dispatch a digital agent 126 to a meeting on behalf of a user 110 in response to the user 110 declining to attend the meeting. In some aspects, the digital agent dispatcher 121 may be configured to dispatch a digital agent 126 to a meeting on behalf of a user 110 in response to determining that the meeting appears on a calendar associated with the user 110 and that the user 110 is not personally attending the meeting. In some such aspects, the digital agent dispatcher 121 may be configured to dispatch a digital agent 126 to a meeting on behalf of a user 110 in response to determining that the meeting appears on a calendar associated with the user 110 if the user profile 128 associated with the user 110 indicates that the user has requested that digital agents 126 be dispatched to all meetings (or particular meetings) that appear on the calendar associated with the user 110 but that are not being personally attended by the user 100.

In some aspects, to dispatch a digital agent 126 to attend a meeting on behalf of a user 110, the digital agent dispatcher 121 may retrieve, from the database 112, a user profile 128 based a user identifier (ID) associated with the user 110, and provide the user profile 128 as an input to a digital agent 126 that may be instantiated to attend the meeting on behalf of the user 110. The digital agent 126 may then attend the meeting on behalf of the user 110 to identify, in information shared during the meeting, a subset of information that may include one or more items of information relevant to the user 110. For example, the digital agent 126 may monitor information that may be shared during the meeting to attempt to match various topics, points, comments, etc., shared during the meeting to information included in the user profile 128. In aspects, the digital agent 126 may employ one or more neural networks or other AI modules to identify various topics, points, comments, etc. in information shared during the meeting and to attempt to match the topics, points, comments, to areas of interest or expertise that may be indicated in the user profile 128. The digital agent 126 may parse out, from the information shared during the meeting, items of information (e.g., comments, points, documents, portions of documents, etc.) that match areas of interest or expertise indicated in the user profile 128 associated with the user 110.

In some aspects, the user 110 may modify and/or adapt the user profile 128 for the particular meeting. For example, in some aspects, the user 110 may specify one or more filters for filtering out only specific information that the user 110 is interested in receiving from the particular meeting. In an aspect, a user 110 may indicate, via a user interface that may be displayed to the user 110 on the user device 102 of the user 110, that the user 110 may be interested in only one or several specific topics, from among a set of topics of interest, that may be included in the user profile 128, that may identified to the user 110 in the particular meeting. As another example, the user 110 may provide, via the user interface that may be displayed to the user 110 on the user device 102 of the user 110, one or more triggers indicating additional specific topics, points, words, terms, phrases, etc. that may not be initially included in a set of topics of interest in the user profile 128 but that may be of interest to the user 110 in the particular meeting. In such aspects, the digital agent dispatcher 121 may provide the modified and/or adapted user profile 128 as an input to the digital agent 126 dispatched to attend the particular meeting on behalf of the user 110 and/or may provide the one or more filters and/or triggers as additional inputs to the digital agent 126 to be used for identifying items of information relevant to the user 110 in the particular meeting.

In aspects, a digital agent 126 that is dispatched on behalf of a user 110 to a particular meeting may be adapted to the particular meeting, for example based on meeting characteristics and/or other information that may be known or detected about the particular meeting or detected by the digital agent 126 during the meeting. Such meeting information for a particular meeting may be retrieved by the digital agent dispatcher 121 from a meeting profile 134 that may be stored in the database 112 in association with the particular meeting, for example. The meeting information may include a title of the meeting, a description that may have been included in an invitation for the meeting, a list of users that were invited to the meeting, a list of users that have accepted the meeting, etc. In some aspects, the digital agent 126 may be configured to detect meeting characteristics, such interaction characteristics, during the meeting, and to dynamically adapt to the meeting characteristics during the meeting. As just an example, the digital agent 126 may be configured to detect, and adapt to, interaction characteristics of the meeting, such whether the meeting is a presentation or more of an interactive meeting, a degree of interaction during the meeting, etc.

With continued reference to FIG. 1, the digital agent presence system 123 may be configured to obtain the items of information identified by the digital agents 126 and to act upon the information obtained from the digital agents 126. In aspects, the digital agent presence system 123 may be configured to determine whether respective ones of the items of information should be presented, in some form, to the users 110. Such items of information may then be presented to a user 110 in real time during a meeting being attended on by a digital agent 126 on behalf of the user 110 and/or included in a listing, such as a summary, that may be provided to a user 110 after completion of the meeting). In aspects, the digital agent presence system 123 may be configured to determine whether respective ones of the items of information should be presented to the users 110 based, at least in part, on priorities of the meetings in which the items of information were identified by the digital agents 126. Such meeting priorities may be provided by the users 110, for example at the time of dispatch of the digital agents 126 to attend the meetings on behalf of the users 110, and/or may be determined the digital agent presence system 123 based on meeting information associated with the meetings.

In aspects, the digital agent presence system 123 may be configured to determine priorities of respective items of information identified by the digital agents 126 based, for example, on absolute or relative priorities of meetings attended by the digital agents 126 and/or other attributes, such as types of items of information, specific content in the items of information, etc. In some aspects, the digital agent presence system 123 is configured to determine that a particular item of information identified by a virtual agent 126 attending a meeting on behalf of a user 110 should be presented to the user 110 if a priority determined for the particular item of information exceeds (or meets) a predetermined or a dynamically determined threshold. Additionally or alternatively, in some aspects, the digital agent presence system 123 is configured to determine that particular items of information identified by respective digital agents 126 attending respective meetings on behalf of the user 110 based on prioritizing relative importance of items of information identified by the respective digital agents 126. As an example, the digital agent presence system 123 is configured to determine that particular items of information identified by a first digital agent 126 attending a first meeting on behalf of a user 110 should be presented to the user 110 if the particular items of information have relatively higher priorities as compared to priorities of items of information identified by a second digital agent 126 attending a second meeting on behalf of the user 110. In this case, the digital agent presence system 123 may cause the particular items of information identified by the first digital agent 126 to be presented to the user 110, and not cause any items of information identified by the second digital agent 126 to be presented to the user 110, for example. In other aspects, other suitable determination techniques may be utilized.

In aspects, the digital agent presence system 123 may be configured to prepare summaries of meetings attended by the digital agents on behalf of users 110 and to preset the summaries to the users 110. Preparing a summary for a user 110 may include ranking or otherwise prioritizing items of information in the subsets of information identified for the user 110 by one or more digital agents 126, based, for example, on importance of the different meetings attended by the one or more digital agents 126, importance of various topics to the user 110, etc., and generating a prioritized listing of the items of information to be presented to the user 110. For example, the digital agent presence system 123 may rank various items of information (e.g., comments, statements, mentions, etc. that occurred during one or more meetings) identified by one or more digital agents 126 for the user 110, and may generate a summary that may include only higher-ranked items of information for presentation to the user 110, include higher-ranked information closer to a beginning of a summary to be presented to the user 110, highlight higher-ranked information in the summary, etc. In some aspects, the digital agent presence system 123 may rank the items of information based, at least in part, on absolute or relative priorities of the meetings attended by the one or more digital agents 126 on behalf of the user 110 and/or other attributes, such as types of items of information, specific content in the items of information, etc. In some cases, if no items of information obtained from particular one or more meetings have sufficiently high priorities (e.g., priorities that exceed or meet a predetermined or a dynamically determined threshold), the digital agent presence system 123 may generate an empty listing, provide no listing and/or provide an indication to the user 110 that no important information was obtained from the particular one or more meetings.

In some aspects, the digital agent presence system 123 may be configured to determine a timing for presenting certain items of information identified by a digital agent 126 to a user 110 and/or notifying the user 110 of certain events that may have occurred during the meeting. For example, the digital agent presence system 123 may determine that an item of information identified by a digital agent 126 during a particular meeting should be presented to the user 110 in real-time during the meeting as the item of information is received by the digital agent presence system 123 from the digital agent 126 during the meeting. On the other hand, in some aspects, the digital agent presence system 123 may determine that other information that may be identified by a digital agent 126 during the meeting need not be presented to the user 110 in real time during the meeting, and may instead merely include such information in a summary that may be provided to the user 110 after the meeting, for example. Thus, in aspects, the user 110 may receive various items of information and/or notifications from one or more meetings, attended by one or more digital agents 126 on behalf of the user 110, at appropriate times during or after the meetings.

With continued reference to FIG. 1, in some aspects, the digital agent presence system 123 may be configured to enable coordination between multiple digital agents 126, such as multiple digital agents 126 that may be dispatched to attend a particular meeting on behalf of multiple users 110. For example, the digital agent presence system 123 may be configured to determine commonalities between digital agents 126 that are attending the meeting on behalf of the multiple users 110, such as such as common topics or areas of interest or expertise between the users 110. Based on such commonalities, the digital agent presence system 123 may coordinate between the digital agents 110 such that only one of the digital agents 126 monitoring the meeting identifies items of information that are commonly relevant to the multiple users 110, while other digital agents 126 may identify items of information that are uniquely relevant to respective ones of the users 110. The digital agent presence system 123 may be configured to communicate the identified items of information that are commonly relevant to the multiple users 110, as needed, to respective ones of the multiple users 110. In aspects, because only a single digital agent 126 may be configured to identify information relevant multiple users 110, computational resources used by the digital agents 126 attending the meeting may be reduced. Further, the overall amount of information that the digital agents 126 pass to the digital agent presence system during the meeting may be reduced, which, in at least some examples, may improve overall efficiency and operation of the system.

It is noted that although the digital agent presence system 123 is illustrated in FIG. 1 as a component that is separate from the digital agents 126, at least some of the functionality described herein in connection with the digital agent presence system 123 is included in the digital agents 126, in some embodiments. For example, a digital agent 126 may be configured to rank or otherwise prioritize information in a subset of information identified in a meeting attended on behalf of a user 110 by the digital agent 126, to provide a prioritized list of information in the subset of information to the user 110 and/or provide real-time notifications to the user 110.

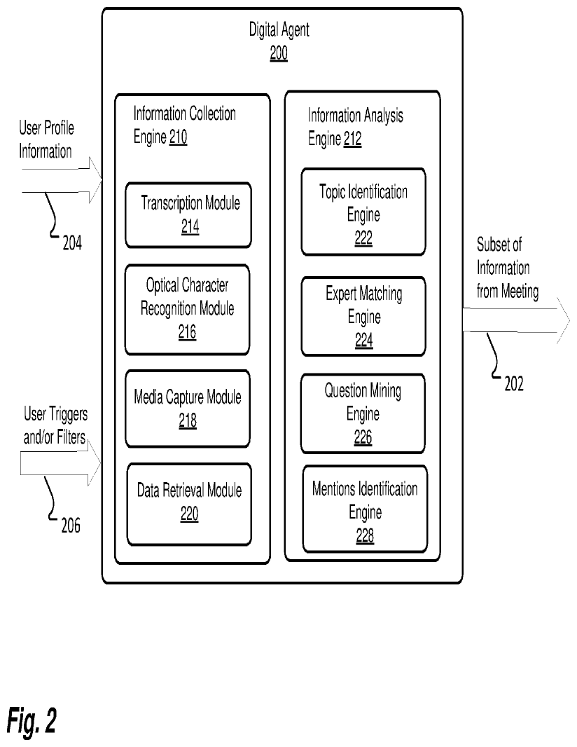

FIG. 2 depicts an example of a digital agent 200, in accordance with aspects of the present disclosure. In an example, the digital agent 200 corresponds to a digital agent 126 of FIG. 1. For ease of explanation, the digital agent 200 is described with reference to FIG. 1. In particular, the digital agent 200 is described in the context of being dispatched by the digital agent dispatcher 121 to attend a meeting on behalf of a user 110. In another example, the digital agent 200 may be utilized in a system different from the system 100 of FIG. 1.

In aspects, the digital agent 200 is configured to monitor information that may be shared during the meeting and to identify, in the information shared during the meeting, a subset of information 202 that may be relevant to the user 110. In aspects, the digital agent 200 may identify the subset of information based on user profile information 204 associated with the user 110 and/or one or more triggers and/or filters 206 that may be specified by the user 110. The user profile information 204 may correspond to the user profile 128 associated with the user 110, and may include various information inferred and/or known about the user 110 as described with reference to the user profiles 128. The digital agent 200 may be trained or otherwise configured to identify, based on the user profile information 204, the subset of information 202 that may be relevant to the user 110 according, for example, to areas of interest or expertise of the user 110. The one or more triggers and/or filters 206 may be provided by the user 110 for the specific meeting being attended by the digital agent 200 on behalf of the user 110. The one or more triggers and/or filters 206 may thus be used by the digital agent 200 to identify additional information that may be relevant to the user and/or to filter out information in which the user may not be interested for the particular meeting.

The includes an information collection engine 210 and an information analysis engine 212. The information collection engine 210 may be configured to obtain information that may be shared between participants in the meeting. In aspects, the information collection engine 212 may include one or more information capture modules for obtaining one or more types of information that may be shared during the meeting and/or converting the information into suitable format that may be provided for analyses by the information analysis engine 212. The one or more information capture modules may include a transcription module 214, an optical character recognition (OCR) module 216, a media capture module 218, and a data retrieval module 220. In some aspects, the information collection engine 210 may omit one or more of the information capture modules 214-220 illustrated in FIG. 2 and/or may include one or more additional information capture modules not illustrated in FIG. 2.

The transcription module 214 may comprise an engine, such as a speech to text engine, configured to covert audio data that may be obtained from the meeting, such as various conversations or other spoken content during the meeting, to text or other format may be suitable for analysis by the information analysis engine 212. The OCR engine 212 may be configured to convert content that may be presented in documents, such as presentation slides, text documents, etc., that may be shared during the meeting, to text or other format may be suitable for further analysis by the information analysis engine 212. The media capture module 214 may be configured to obtain captures of one or more types of media that may be used during the meeting, such as to obtain screen shots or screen recordings containing media presentations (e.g., documents or videos) shared during the meeting. The data retrieval module 216 may be configured to retrieve data, such as documents, videos, etc., that may be shared during the meeting, for example if the digital agent 200 has, or may obtain, access to a data store that may, for example, be coupled to the application server 106 via the network 108, that contains the documents, videos, etc., shared during the meeting.

The information analysis engine 212 may be configured to analyze or otherwise process information obtained by the information collection engine 210 to identify items of information that may be relevant to the user 110, such as comments, text mentions, statements, points, questions etc. made during the meeting that may match of be within areas of interest or expertise of the user 110. In some aspects, the information analysis engine 212 may operate in real time to identify specific information as the information is obtained by the information collection engine 210 throughput the meeting. In some aspects, the information analysis engine 212 may additionally or alternatively operate at another time, such as after the meeting, to identify specific information in the information obtained by the information collection engine 210 during the meeting.

The information analysis engine 212 may comprise one or more information analysis modules, such as AI modules (e.g., neural networks) or other types of modules, trained or otherwise configured to identify specific information in information obtained by the information collection engine 210. The one or more information analysis modules may include a topic identification module 222, an expert matching module 224, a question mining module 226 and a mentions identification module 228. Although, the information analysis modules 222-228 are illustrated in FIG. 2 as separate modules, at least some of the information analysis modules 222-228 maybe replaced by a single module (e.g., a single neural network) that may be trained or otherwise configured to implement combined functionality of the least some of the information analysis modules 222-228. Further, in some aspects, the information analysis engine 212 may omit one or more of the information capture modules 222-228 illustrated in FIG. 2 and/or may include one or more additional information capture modules not illustrated in FIG. 2.

The topic identification module 222 may be configured to identify, in the in information obtained by the information collection engine 210, items of information (e.g., comment, statement, document, etc.) relating to a topic that may match or be within one or more areas of interest of the user 110. The expert matching module 224 may be configured to identify, in the in information obtained by the information collection engine 210, items information (e.g., comment, statement, document, etc.) relating to a topic that may match or be within one or more areas of expertise of the user 110. The question mining module 226 may be configured to identify, in the in information obtained by the information collection engine 210, questions that the user 110 may be able to answer, or may know another person who may be able to answer. The mentions identification module 228, may be configured to identify, in the in information obtained by the information collection engine 210, items of information that include specific mentions of the name of the user 110 and/or of specific terms, words, phrases etc., that are indicated (in the user profile information 204 and/or trigger 206) as being of interest to the user 110.

In some aspects, the digital agent 200 may be configured to filter the items of information identified by the information analysis engine 212 in accordance with one or more filters 206 provided by the user 110, for example to ensure that only items of information relating to one or more specific topics or points of interest indicated for the meeting by the user 110 are included in the subset of information 202. In some aspects the digital agent 200 may be configured to rank or otherwise prioritize the items of information identified by the information analysis engine 212, and to include a prioritized list of the items of information identified by the information analysis engine 212 in the subset of information 202. The digital agent 200 may be configured to provide the subset of information 202, to the user 110 and or to provide the subset of information 202 to the digital agent presence system 123. In some aspects, the digital agent 200 may be further configured to determine, in real-time, that the user 110 should be provided a notification regarding an item of information identified by the information analysis engine 212 and, in some such cases, the digital agent 200 may provide such notification, in some form, in real time to the user 110.

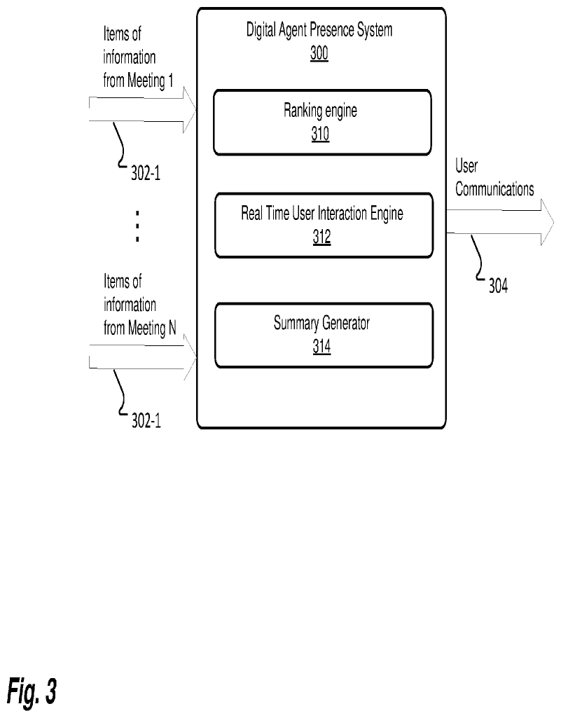

FIG. 3 depicts an example of a digital agent presence system 300, in accordance with aspects of the present disclosure. In an example, the digital agent presence system 300 corresponds to the digital agent presence system 123 of FIG. 1. For ease of explanation, the digital agent presence system 300 is described with reference to FIG. 1. In another example, the digital agent presence system 300 may be utilized in a system different from the system 100 of FIG. 1 or the system 300 of FIG. 3.

The digital agent presence system 300 is configured to receive items of information 300 identified (e.g., by one or more digital agents 126) in information shared during one or more meetings attended on behalf of a user 110 by the one or more digital agents 126, and generate user communications 304 to provide relevant information from the one or more meetings to the user 110. In some aspects, the meetings attended by the digital agents 126 on behalf of the user 110 may include meetings occurring simultaneously (e.g., parallel-in-time, overlapping, etc.) with each other and/or may be occurring at different times throughout a certain time period (e.g., throughput a day). The digital agent presence system 300 may include a ranking engine 310, a real time user interaction engine 312 and a summary generator 314. The ranking engine 310 may be configured to rank the items of information 302 from the various meetings attended by the one or more digital agents 126 on behalf of the user 110. In some aspects, the ranking engine 310 may rank the items of information 302 based on respective degrees of importance of meetings from which the items of information 302 were obtained by the digital agents 126. The degrees of importance of meetings may be determined by the digital agent presence system 300 based on explicit indications of importance that may be provided by the user 110 and/or may be inferred from meeting information, such as information (e.g., meeting title, list of attendees, meeting interaction type, etc.) that may be retrieved from a meeting profile associated with the meeting and/or may be dynamically detected by the digital agents 116 attending the meetings.

The real time interaction engine 312 may be configured to determine, based on the items of information 302, whether the user 110 should be contacted in real time as the items of information are identified in the meetings attended by the digital agents 126 on behalf of the user 110. Such determinations may be made by the real time interaction engine 312 based on meeting importance, item importance, user profile, other queues that may be obtained from the meeting by the digital agents 126, etc. In response to determining that the user 110 is to be notified in real time, the real time interaction engine 312 may generate a communication to notify the user 110 and may send the communication to the user device 102 of the user 110, for example.

The summary generator 314 may be configured to generate a summary that includes a suitable listing of at least some the items of information 302 identified for the user 110. The summary may include a prioritized listing of the items of information 302, or of a subset of items of information 302 that may selected for presentation to the user by the digital agent presence system 300. The summary may comprise respective per-meeting prioritized listings of items of information identified during respective meetings and/or may comprises a listing of items of information prioritized across multiple meetings. In some examples, prioritized listings of the items of information may enhance user experience and usefulness of the summary provided to the user 110, for example by ensuring that more important items of information are presented closer to a beginning of the summary and/or are in some way heighted in the summary. In some examples, the summary may additionally or alternatively include a per-meeting temporal, non-prioritized, listing of items of information 302, for example to provide the user 110 with a more detailed overview of the flow of information during the meeting. In other aspects, the summary generator 314 may be configured to generate other suitable forms of summaries to present some or all of the items of information 302 to the user 110. In some examples, the summary generator 314 is configured to generate the summary for the user 110 in accordance with user preferences and/or summary formats that may be obtained by the digital agent presence system 300 for example from a user profile (e.g., the user profile 128) associated with the user 110.

The digital agent presence system 300 may be configured to provide the summary generated for a user 110 by the summary generator 314 to the user 110. For example, the digital agent presence system 300 may generate a user communication 304, such as an e-mail, a text message, etc., to include the summary generated by the summary generator 314 and cause the user communication 304 to be transmitted via the network 108 to the user device 102 of the user 110. In some aspects, the digital agent presence system 300 may be configured to provide the summary, in some form, to the meeting application 104 of the user 110. The meeting application 104 may be configured to present the summary to the user 110 via a user interface displayed on a display of the user device 102. In other aspects, the summary generated by the summary generator 314 and/or individual items of information 302 may be presented to the user 110 in other suitable manners.

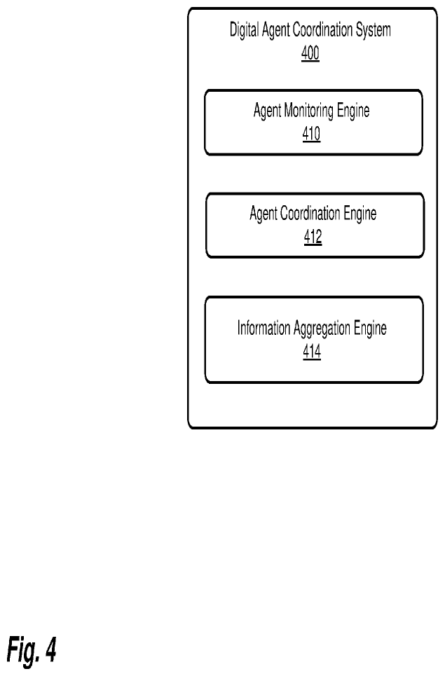

FIG. 4 depicts an example of a digital agent coordination system 400, in accordance with aspects of the present disclosure. In an example, the digital agent coordination system 400 is included in the digital agent presence system 300 and/or the digital agent presence system 123 of FIG. 1. For ease of explanation, the digital agent coordination system 400 is described with reference to FIGS. 1 and 3. In another example, the digital agent coordination system 400 may be utilized in a system different from the system 100 of FIG. 1 or the system 300 of FIG. 3.

The digital agent coordination system 400 may enable coordination between digital agents 126, such as digital agents 126 that may be dispatched to attend a same meeting on behalf of different users 110. It is noted that although the digital agent coordination system 400 is generally described herein as being a part of the digital agent presence system 300 and/or the digital agent presence system 123 of FIG. 1, at least some functionality of the digital agent coordination system 400 that enables coordination between digital agents 126 may be internal to the digital agents 126. For example, the digital agents 126 may include communication interfaces for communicating with other digital agents 126, for example to enable coordination between digital agents 126 that may be attending a same meeting on behalf of different users 110.

The digital agent coordination system 400 may include an agent monitoring engine 410, an agent coordination engine 412 and an information aggregation engine 414. The agent monitoring engine 410 may be configured to determine commonalities between digital agents 126 that are attending the meeting on behalf of the users 110. Commonalities that may be determined by the agent monitoring engine 410 may include, for example, areas of interest, expertise, topics, words, terms of interest etc. that are common among multiple ones of the users 110. Such commonalities may be determined by the agent monitoring engine 410 at least partially before a start of the meeting, for example based on digital agent participation information may be obtained from a meeting profile associated with the meeting. The agent monitoring engine 410 may additionally or alternatively determine such commonalities dynamically during the meeting, for example by monitoring and interacting with the digital agents 126 that are attending the meeting.

The agent coordination engine 414 may, based upon the commonalities determined by the agent monitoring engine 410, consolidate certain functionalities of the multiple digital agents 126. For example, the agent coordination engine 414 may select one of the multiple digital agents 126 for identifying items of information that may be commonly relevant to the multiple users 110, and to limit the other ones of the multiple digital agents 126 to identifying items of information that are uniquely relevant to the users 110 associated with the digital agents 126. As another example, the agent coordination engine 414 may insatiate a separate meta-agent 126 to monitor the meeting on behalf of the multiple users 110 to identify items of information that may be commonly relevant to the multiple users 110, and to limit the digital agents 126 to identifying items of information that are uniquely relevant to the users 110 associated with the digital agents 126.

The information aggregation engine 414 may obtain the items of information identified by the selected digital agent 126 or the meta agent 126 on behalf of the multiple users 110 and to ensure that such items of information are considered for presentation to each of the multiple users 110. In aspects, because only a single digital agent 126 may be configured to identify information relevant multiple users 110, computational resources used by the digital agents 126 attending the meeting may be reduced. Further, the overall amount of information that the digital agents 126 pass to the digital agent presence system during the meeting may be reduced, which, in at least some examples, may improve overall efficiency and operation of the system.

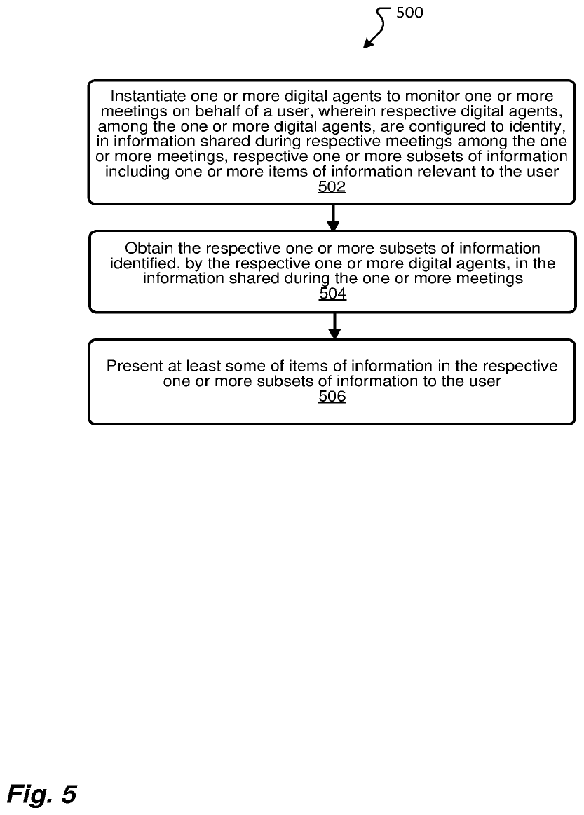

FIG. 5 depicts details of a method 500 for providing meeting information to a user, in accordance with aspects of the present disclosure. A general order for the steps of the method 500 is shown in FIG. 5. The method 500 can be executed as a set of computer-executable instructions executed by a computer system and encoded or stored on a computer readable medium. Further, the method 500 can be performed by gates or circuits associated with a processor, Application Specific Integrated Circuit (ASIC), a field programmable gate array (FPGA), a system on chip (SOC), or other hardware device. Hereinafter, the method 500 shall be explained with reference to the systems, components, modules, software, data structures, user interfaces, etc. described in conjunction with FIGS. 1-4.

At block 502, instantiating one or more digital agents to monitor one or more meetings on behalf of a user 110. For example, one or more digital agents 200 may be instantiated. In other aspects, suitable digital agents different from the digital agents 200 may be instantiated. In aspects, respective digital agents are configured to dynamically identify, in information shared during the one or more meetings, sub sets of information containing items of information relevant to the user 110. In some aspects, the one or more meetings monitored by the one or more digital agents may include concurrent or simultaneous meetings. In some aspects, the one or more meetings monitored by the one or more digital agents may include at least one meeting that is concurrent or simultaneous with a meeting being personally attended by the user 110 via a meeting application on a user device 102 of the user 110.

At block 504, obtaining the respective one or more subsets of information identified, by the respective one or more digital agents, in the information shared during the one or more meetings. For example, the one or more subsets of information are obtained by a digital agent presence system, such as the digital agent presence system 123. In another aspect, the one or more subsets of information are obtained by a digital agent presence system different from the digital agent presence system 123.

At block 506, at least some items of information in the respective subsets of information are presented to the user. The items of information may include comments, statements, mentions, questions etc. that occur during the meeting, documents or relevant portions of documents (e.g., word documents, presentation slides, etc.) that are shared during the meeting, screen shots from the meeting, etc. In an aspect, a summary of items of information identified as relevant to the user 110 in the one or more meeting may be generated by the digital agent presence system 123 and may be transmitted over the network 108 to the user device 102 of the user 110. The summary of items of information may include one or more of i) a per-meeting prioritized listing of the items of information, ii) a listing of items of information prioritized across multiple meetings, iii) a temporal listing of items of information in the order in which the items were presented during the meeting, etc. In some aspects, the summary may include relevant portions of documents, documents in which information relevant to the user 110 is highlighted or identified in another suitable manner, such as an arrow pointing to relevant content within the documents, etc. In some aspects, at least some items of information trigger a real-time notification to be provided to the user 110 to enable the user 110 to act upon the items of information in real time, such as to provide an answer to a question at an appropriate time during the meeting.

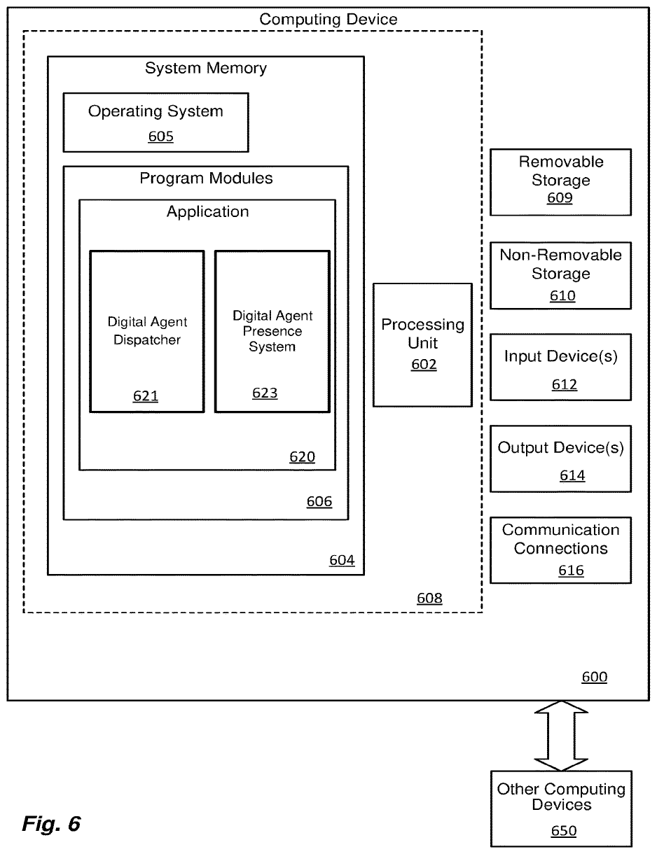

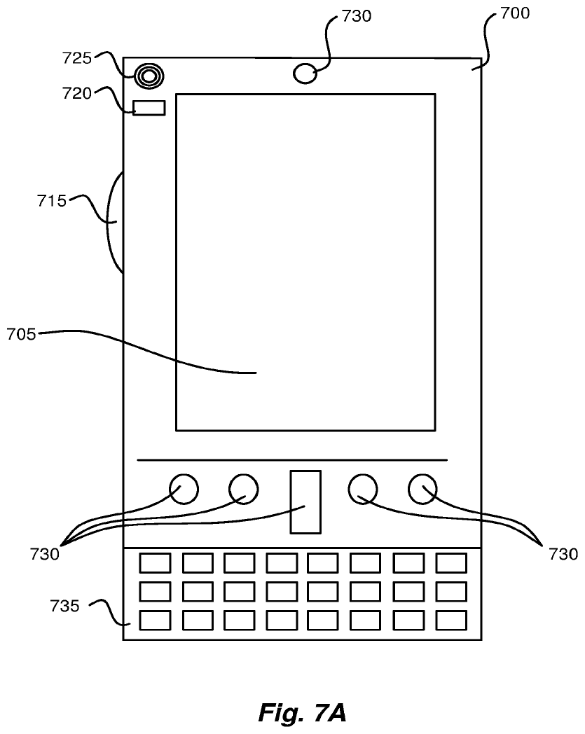

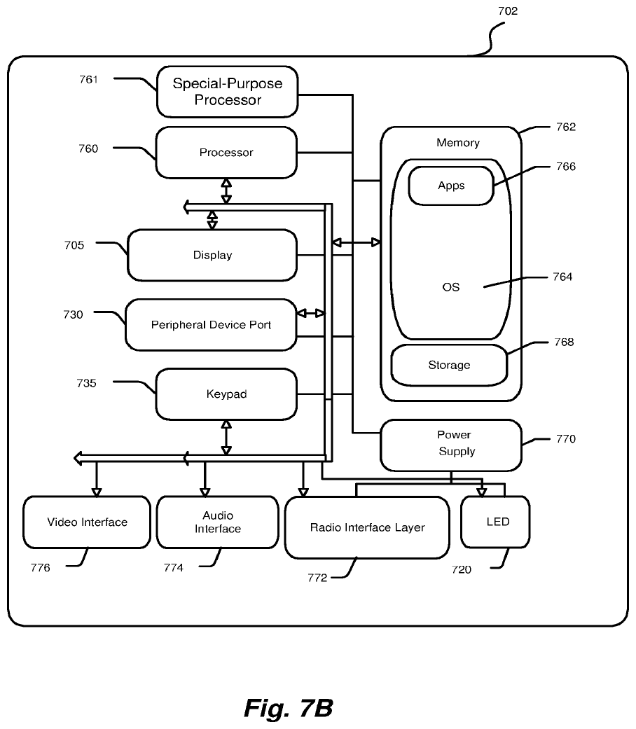

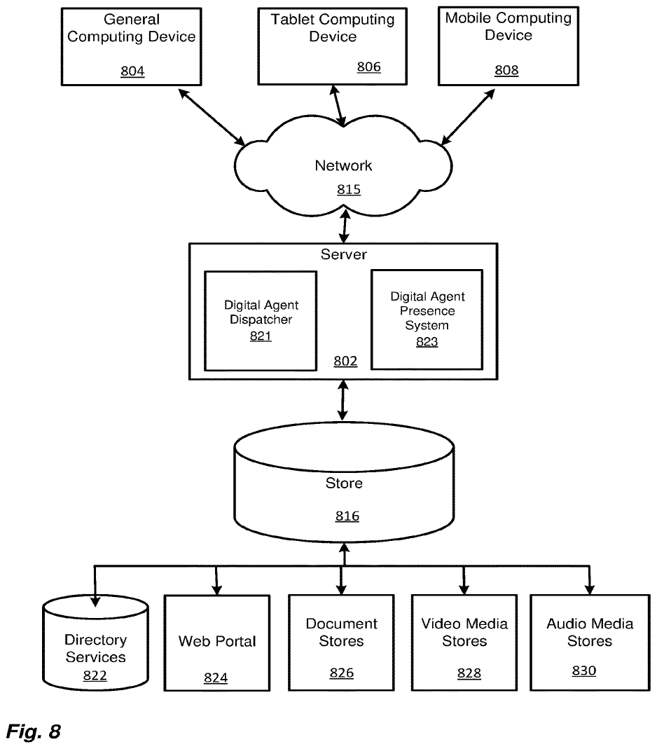

FIGS. 6-7 and the associated descriptions provide a discussion of a variety of operating environments in which aspects of the disclosure may be practiced. However, the devices and systems illustrated and discussed with respect to FIGS. 6-7 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store a digital agent dispatcher 621 (e.g., corresponding to the digital agent dispatcher 121 of FIG. 1) and/or a digital agent presence system 623 (e.g., corresponding to the digital agent presence system 123 of FIG. 1). The operating system 605, for example, may be suitable for controlling the operation of the computing device 600.

Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the at least one processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 7A-7B illustrate a mobile computing device 700, for example, a mobile telephone, a smart phone, wearable computer (such as a smart watch), a tablet computer, a laptop computer, and the like, with which aspects of the disclosure may be practiced. In some aspects, the client (e.g., computing system 104A-E) may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external source.

FIG. 7B is a block diagram illustrating the architecture of one aspect of computing device, a server, or a mobile computing device. That is, the computing device 700 can incorporate a system (e.g., an architecture) 702 to implement some aspects. The system 702 can implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700 described herein (e.g., search engine, extractor module, relevancy ranking module, answer scoring module, etc.).

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated configuration, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems ..

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an application data stores 928, or application services 930.

A digital agent dispatcher 921 (e.g., corresponding to the digital agent dispatcher 121 of FIG. 1) and a digital agent presence system 923 (e.g., corresponding to the digital agent presence system 123 of FIG. 1) may be employed by a client that communicates with server device 902, and/or the digital agent dispatcher 921 and/or the digital agent presence system 923 may be employed by server device 902. The server device 902 may provide data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these examples of the computing devices may obtain content from the store 916, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1-20. (canceled)

21. A computer-implemented method comprising:
receiving communication session data relating to a plurality of communication sessions that involve video or audio communication involving multiple user devices over a computer network;
determining that a particular user will not personally participate in a particular communication session from the plurality of communication sessions;
in response to determining that a particular user will not personally participate in the particular communication session, dispatching a digital agent to monitor the particular communication session on behalf of the particular user, the digital agent being configured to extract a relevant subset of information from the particular communication session for the particular user by applying a machine learning model to at least one of audio or video data presented during the particular communication session;
receiving the relevant subset of information from the digital agent; and
transmitting the relevant subset of information over the computer network to a particular computing device associated with the particular user.

22. The computer-implemented method of claim 21, further comprising:
dispatching the digital agent to monitor the particular communication session in response to detecting that the particular communication session is present on a calendar of the particular user and that the particular user is not personally attending the particular communication session.

23. The computer-implemented method of claim 21, further comprising:
dispatching the digital agent to monitor the particular communication session in response to detecting that the particular user declined an invite to attend the particular communication session.

24. The computer-implemented method of claim 21, further comprising:
outputting the relevant subset of information to the particular user while the user is participating in another concurrent communication session.

25. The computer-implemented method of claim 21, further comprising:
receiving user input from the particular user specifying filtering criteria for filtering information; and
configuring the digital agent to filter out other information presented during the particular communication session that does not meet the filtering criteria,
wherein the relevant subset of information transmitted over the computer network to the particular computing device associated with the particular user excludes the other information that is filtered out by the digital agent.

26. The computer-implemented method of claim 21, further comprising:
receiving user input from the particular user specifying triggering criteria for information to be presented to the particular user; and
configuring the digital agent to identify information presented during the particular communication session that meets the triggering criteria,
wherein the relevant subset of information transmitted over the computer network to the particular computing device associated with the particular user excludes other information that does not meet the triggering criteria.

27. The computer-implemented method of claim 21, further comprising:
training the machine learning model based at least on a user profile for the particular user to identify the relevant subset of information to present to the particular user,
wherein the relevant subset of information transmitted over the computer network to the particular computing device associated with the particular user excludes other information that the trained machine learning model determines is not relevant to the particular user.

28. The computer-implemented method of claim 21, further comprising:
by the digital agent, selecting a first item of information from the relevant subset to transmit to the particular computing device associated with the particular user in real time; and
transmitting the first item of information to the particular computing device in real time.

29. The computer-implemented method of claim 28, further comprising:
by the digital agent, selecting a second item of information from the relevant subset for deferred transmission to the particular computing device associated with the particular user; and
transmitting the second item of information to the particular computing device after the particular communication session is completed.

30. A system, comprising:
at least one hardware processor; and
memory coupled to the at least one hardware processor, the memory comprising computer executable instructions that, when executed by the at least one hardware processor, cause the system to:
receive communication session data relating to a plurality of communication sessions that involve video or audio communication involving multiple user devices over a computer network;
determine that a particular user will not personally participate in a particular communication session from the plurality of communication sessions;
in response to determining that a particular user will not personally participate in the particular communication session, dispatch a digital agent to monitor the particular communication session on behalf of the particular user, the digital agent being configured to extract a relevant subset of information from the particular communication session for the particular user by applying a machine learning model to at least one of audio or video data presented during the particular communication session;
receive the relevant subset of information from the digital agent; and
transmit the relevant subset of information over the computer network to a particular computing device associated with the particular user.

31. The system of claim 30, wherein the computer executable instructions, when executed by the at least one hardware processor, further cause the system to:
dispatch the digital agent to monitor the particular communication session in response to detecting that the particular communication session is present on a calendar of the particular user and that the particular user is not personally attending the particular communication session.

32. The system of claim 30, wherein the computer executable instructions, when executed by the at least one hardware processor, further cause the system to:
dispatch the digital agent to monitor the particular communication session in response to detecting that the particular user declined an invite to attend the particular communication session.

33. The system of claim 30, wherein the computer executable instructions, when executed by the at least one hardware processor, further cause the system to:
output the relevant subset of information to the particular user while the user is participating in another concurrent communication session.

34. The system of claim 30, wherein the computer executable instructions, when executed by the at least one hardware processor, further cause the system to:
receive user input from the particular user specifying filtering criteria for filtering information; and
configure the digital agent to filter out other information presented during the particular communication session that does not meet the filtering criteria,
wherein the relevant subset of information transmitted over the computer network to the particular computing device associated with the particular user excludes the other information that is filtered out by the digital agent.

35. The system of claim 30, wherein the computer executable instructions, when executed by the at least one hardware processor, further cause the system to:
receive user input from the particular user specifying triggering criteria for information to be presented to the particular user; and
configure the digital agent to identify information presented during the particular communication session that meets the triggering criteria,
wherein the relevant subset of information transmitted over the computer network to the particular computing device associated with the particular user excludes other information that does not meet the triggering criteria.

36. The system of claim 30, wherein the computer executable instructions, when executed by the at least one hardware processor, further cause the system to:
train the machine learning model based at least on a user profile for the particular user to identify the relevant subset of information to present to the particular user,
wherein the relevant subset of information transmitted over the computer network to the particular computing device associated with the particular user excludes other information that the trained machine learning model determines is not relevant to the particular user.

37. The system of claim 30, wherein the computer executable instructions, when executed by the at least one hardware processor, further cause the system to:
by the digital agent, select a first item of information from the relevant subset to transmit to the particular computing device associated with the particular user in real time; and
transmit the first item of information to the particular computing device in real time.

38. The system of claim 37, wherein the computer executable instructions, when executed by the at least one hardware processor, further cause the system to:
by the digital agent, select a second item of information from the relevant subset for deferred transmission to the particular computing device associated with the particular user; and
transmit the second item of information to the particular computing device after the particular communication session is completed.

39. A computer storage medium computer executable instructions that, when executed by a hardware processor, cause the hardware processor to perform acts comprising:
receiving communication session data relating to a plurality of communication sessions that involve video or audio communication involving multiple user devices over a computer network;
determining that a particular user will not personally participate in a particular communication session from the plurality of communication sessions;
in response to determining that a particular user will not personally participate in the particular communication session, dispatching a digital agent to monitor the particular communication session on behalf of the particular user, the digital agent being configured to extract a relevant subset of information from the particular communication session for the particular user by applying a machine learning model to at least one of audio or video data presented during the particular communication session;
receiving the relevant subset of information from the digital agent; and
transmitting the relevant subset of information over the computer network to a particular computing device associated with the particular user.

40. The computer storage medium of claim 39, wherein the machine learning model comprises a neural network that has been trained to identify the relevant subset of information to present to the particular user.
